(19) United States
(12) Patent Application Publication
(10) Pub. No.: US 2009/0264122 A1
(43) Pub. Date: Oct. 22, 2009

(54) Method and System for Updating Home Location Register in Mobile Network

(75) Inventors: Johannes Maria Van Loon, Zoetermeer (NL); Tomas Hector Andre Jozef Cordenier, Delft (NL); Ludovicus Antonius Hermanus Maria Eikhout, Wouw (NL)

Correspondence Address: MICHAELSON & ASSOCIATES, P.O. BOX 8489, RED BANK, NJ, 07701-8489, US

(73) Assignee: Koninklijke KPN N.V., The Hague (NL)

(21) Appl. No.: 11/991,988

(22) PCT Filed: Oct. 3, 2006
(86) PCT No.: PCT/EP06/09564

§ 371 Date: Mar. 13, 2008

Related U.S. Application Data
(60) Provisional application No. 60/723,569, filed on Oct. 4, 2005.

(51) Int. Cl. H04W 8/04

(52) U.S. Cl. 455/433

(57) ABSTRACT

Method of registering a mobile subscriber in a mobile network and network unit for a mobile network having a home location register in which data related to a plurality of active mobile subscribers are stored. A first attempt of a mobile subscriber to attach to the mobile network is detected, and subsequently the home location register is updated by entering data related to the mobile subscriber in the home location register. Data related to a mobile subscriber which is not yet registered in the home location register may be stored in a second register, and the data related to the mobile subscriber is transferred from the second register to the home location register upon detection of the first attempt.

### FIELD OF THE INVENTION

The present invention relates to a method of registering a mobile subscriber (or the international mobile subscriber identity, IMSI) in a mobile network having a home location register in which data related to a plurality of active mobile subscribers are stored. In a further aspect, the present invention relates to a network unit for a mobile network providing communication links to a plurality of active mobile subscribers, the mobile network having a home location register in which data related to the plurality of active mobile subscribers are stored. The mobile subscriber is understood to be an identifying element of a hardware terminal used in the mobile network, such as a (U)SIM card ((Universal) Subscriber Identity Module) with associated data stored thereon.

### PRIOR ART

A new SIM card issued by a mobile telephone company may be related to either a pre-paid or a post-paid telephone account. Each SIM card is associated with an International Mobile Subscriber Identity (IMSI), and part of the process includes generating keys for use with the SIM card. The keys of SIM cards are uploaded into the mobile telephony company's network, more exactly in a Authentication Center (AuC), which is usually part of the unit in the network which implements the Home Location Register (HLR) function of the network (e.g., a Home Subscriber Server HSS). In the HLR, subscriber data is stored related to the SIM card (e.g., the IMSI, Mobile Station International Subscriber Directory Number (MSISDN)) and to the subscription (e.g., subscribed and activated services). This subscriber data is called permanent data. Further temporary data is stored in the HLR related to roaming, e.g., which Mobile Switching Center (MSC) and Visitor Location Register (VLR) is serving the mobile subscriber, and the status of the mobile subscriber (e.g., not reachable, IMSI detached). In all the HLR and AuC comprise a huge amount of subscriber data, of which not all are in active use. This may lead to capacity problems in the systems related to the HLR in a mobile network.

### SUMMARY OF THE INVENTION

The present invention seeks to provide a solution to more efficiently use of resources in a mobile network.

According to the present invention, a method according to the preamble defined above is provided, comprising detecting a first attempt of a mobile subscriber to attach to the mobile network, and subsequently updating the home location register by entering data related to the mobile subscriber in the home location register. By only storing data related to active mobile subscribers which are actually in active use, as triggered by a first attempt of a mobile subscriber to attach to the network, it is possible to lower the storage requirements for the home location register. The first attempt is understood to be the first time when a (U)SIM card is put to active use in the sense of registering the associated IMSI with a mobile network, after issue of the (U)SIM card to a customer.

In a further embodiment, data related to a mobile subscriber which is not yet registered in the home location register, is stored in a second register (also called SIM waiting room or HLR waiting room). The data related to the mobile subscriber is transferred from the second register to the home location register upon detection of the first attempt. This may involve moving or copying of data, or any other method to add the associated data to the home location register. The data can be entered in the second register upon introduction of a (U)SIM card on the market (pre-paid (U)SIM cards), when all details of a post-paid subscription are known, or when all (U)SIM card data is known.

The first attempt may in a further embodiment comprise sending a location update message by the mobile subscriber in the mobile network. In some cellular networks, such as GSM networks, this is a standard method for a mobile subscriber to initiate attachment to a network.

The first attempt may be detected in a number of different embodiments. E.g., the detection may comprise checking whether the data of the mobile subscriber is already present in the home location register, and if not, updating the home location register. This embodiment may be implemented in the hardware unit which implements the home location register, e.g., in the form of a database.

In a further embodiment, the detecting comprises checking whether the data of the mobile subscriber is already present in the home location register, and if not, generating a message, and upon detection of the message, updating the home location register. The message may be an error message, or another suitable signaling message. This embodiment requires no adaptation of the home location register, as this is normally arranged to generate an error or failure message when a specific IMSI can not be found. The generated message may then be detected at another point in the mobile network, e.g., in the operation and maintenance part of the mobile network, or in a dedicated signaling unit (e.g., a C7 link monitor system which monitors data traffic in the mobile network for (intelligent) network messages (also called SS7 signaling)).

In a further embodiment, another functional element of a mobile network may be arranged to detect a first attempt. In this case, the first attempt comprises a message with an identification number (IMSI), and the method further comprises checking the identification number with a list comprising identification numbers, and updating the home location register accordingly. The list may comprise identification numbers associated with the plurality of active mobile subscriber units, in which case updating takes place if the identification number in the message is not in the list. Alternatively, the list comprises identification numbers (IMSI) of not yet activated (U)SIM cards. In that case, the updating takes place if the identification number is in the list. E.g., a signaling transfer point (STP) in a mobile network (possibly in combination with a mobile number portability platform) may be suitable for implementing this embodiment. An STP conventionally comprises such a list of IMSI's for purposes of proper routing of a request to the relevant HLR.

The data associated with an active mobile subscriber is stored in the home location register in a manner in which it can be used instantaneously by other mobile network parts (i.e., technical data). Part of the data associated with an active mobile subscriber unit may comprise authentication data, i.e., key data relating to authentication and encryption. This authentication data may be stored as separate data outside the home location register, e.g., in an authentication center. As both the data in the home location register and in the authentication center are in a technical form, these data may be used in the network instantaneously.

In a further embodiment, upon detection of the first attempt, an authentication key associated with the mobile subscriber is generated and added to the data of the mobile subscriber. Although this requires additional calculation resources at the time when a mobile subscriber is added as an active mobile subscriber, it assures that all data in the home location register and the authentication center to be of a technical nature, as a result of which this data can be accessed and used immediately. The actual calculation of the authentication key may be provided by a dedicated network unit.

In a further embodiment, all data associated with a new mobile subscriber may be of an administrative nature, and upon detection of the first attempt, the data associated with the mobile subscriber is translated into a format suitable for entering in the home location register (and authentication center). Although in this embodiment, always a translation is necessary which requires additional network resources, the management of the (administrative) data before entering may be easier.

In order to allow a smaller size requirement for the home location register in a mobile network, in a further embodiment data in the home location register associated with a mobile subscriber which has not been active for a predetermined time period (e.g., more than three years) is removed from the home location register. E.g., the data is transferred to the second register when available, so that later re-activation of the specific mobile subscriber is easier.

In a second aspect, the present invention relates to a network unit as defined in the preamble above, in which the network unit is arranged to interface with the mobile network and the home location register for detecting a first attempt of a mobile subscriber to attach to the mobile network, and subsequently entering data related to the mobile subscriber in the home location register.

The network unit according to the present invention may be implemented in one of many functional parts of a mobile network, which are already present in the mobile network, or which are added as separate entities and arranged to interface with other units in the mobile network as required. E.g., the network unit may be implemented as a whole or partly in a unit hosting the home location register, as part of the operation and maintenance system of the mobile network, or e.g., as part of the intelligent network signaling system (such as SS7 or C7 signaling system). Also, the present invention may be implemented as part of the signaling transfer point of the mobile network. The resources necessary for translation of certain data in some of the embodiments above may also be implemented in units which are already part of the mobile network, e.g., in back office systems which are used for administration and/or provisioning of the mobile network.

In an even further aspect, the present invention relates to a computer program product comprising computer executable code, which when loaded in a processing unit of at least one network unit in a mobile network, provides the at least one network unit in the mobile network with the functionality of the present method. Again, the computer program may be intended to be used on an already present unit or functional part of the mobile network, or on a separate unit able to interface with the appropriate resources of the mobile network.

### SHORT DESCRIPTION OF DRAWINGS

The present invention will be discussed in more detail below, using a number of exemplary embodiments, with reference to the attached drawings, in which

FIG. 1 shows a schematic diagram of a part of a mobile network system architecture;

FIG. 2 shows a schematic representation of the method according to one embodiment of the present invention;

FIG. 3 shows a schematic diagram of part of a mobile network architecture in which the present invention may be used;

FIG. 4 shows a schematic diagram of the mobile network architecture with data messages according to a first embodiment;

FIG. 5 shows a schematic diagram of the mobile network architecture with data messages according to a second embodiment;

FIG. 6 shows a schematic diagram of the mobile network architecture with data messages according to a third embodiment;

FIG. 7 shows a schematic diagram of the mobile network architecture with data messages according to a fourth embodiment; and

FIG. 8 shows a schematic diagram of the mobile network architecture with data messages according to a fifth embodiment.

### DETAILED DESCRIPTION OF EXEMPLARY EMBODIMENTS

The present invention, which may be applied in mobile telephony networks as known to the skilled person, uses the existing hardware and software resources of the network in some embodiments, and in other embodiments additional hardware or modified software. Only the elements relevant to embodiments of the present invention will be discussed below, as the normal operation of a mobile telephony network is considered to be known to the skilled person.

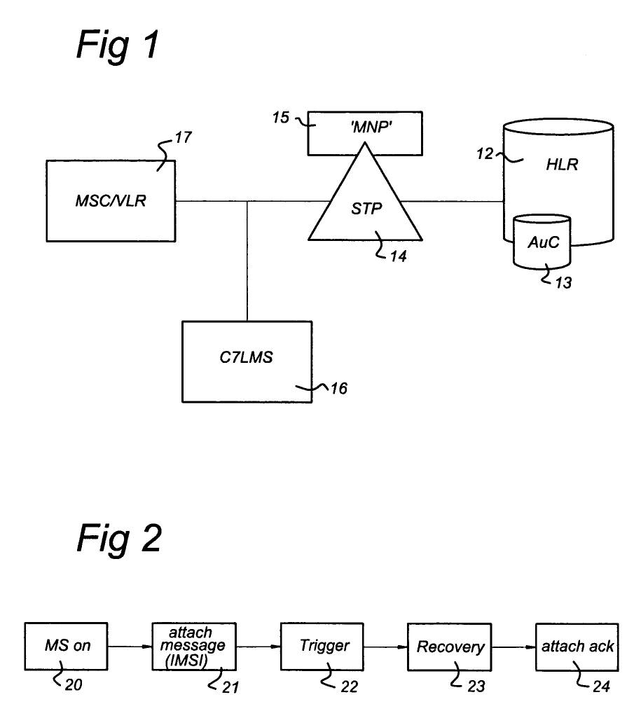

In FIG. 1, relevant parts relating to signaling in a mobile telephony network are shown. The network comprises a Mobile Switching Center (MSC) 17, which interfaces with the Base Stations of the mobile network for radio communication with Mobile (subscriber) Stations. The MSC 17 comprises a Visitor Location Register (VLR). The MSC/VLR 17 interfaces with a Signal Transfer Point (STP) 14 for routing request and data messages to and from a Home Location Register (HLR) 12. Next to the HLR 12, the STP 14 interfaces with an Authentication Center (AuC) 13, which comprises key data for authenticating a mobile subscriber. The HLR 12 and AuC 13 may be provided as separate databases, but in the same hardware equipment. The STP 14 is also interfaced to a Mobile Number portability Platform (MNP) 15 which allows customers to keep a specific mobile phone number when transferring to another network provider. Data messages in the signaling network of FIG. 1 are being monitored by a C7 Link Monitor System (C7LMS) 16, which may also be known as an SS7 monitoring system, or an Intelligent Network (IN) monitoring system. The C7LMS 16 monitors all C7 signaling messages in the network for management purposes, and is arranged to generate alarms or other messages based on the monitored signaling messages. As will be understood by the skilled person, the data may be routed in the mobile network using other elements and other connections.

When a mobile subscriber (the mobile subscriber is understood to be an identifying element of a hardware terminal used in the mobile network, such as but not limited to a (U)SIM card ((Universal) Subscriber Identity Module) with associated data stored thereon) powers up the mobile station having a SIM card, an attach process is initiated in which an International Mobile Subscriber Identification (IMSI) associated with the SIM card is signaled to the network. A location update message is generated from the mobile station to the MSC 17, and via the MSC's VLR the request is routed via the STP 14 to the correct HLR. Depending on whether the data associated with the particular IMSI is available in the HLR 12, acknowledgement messages are returned to the mobile station. In this process, also authentication using the key data in the AuC 13 is performed.

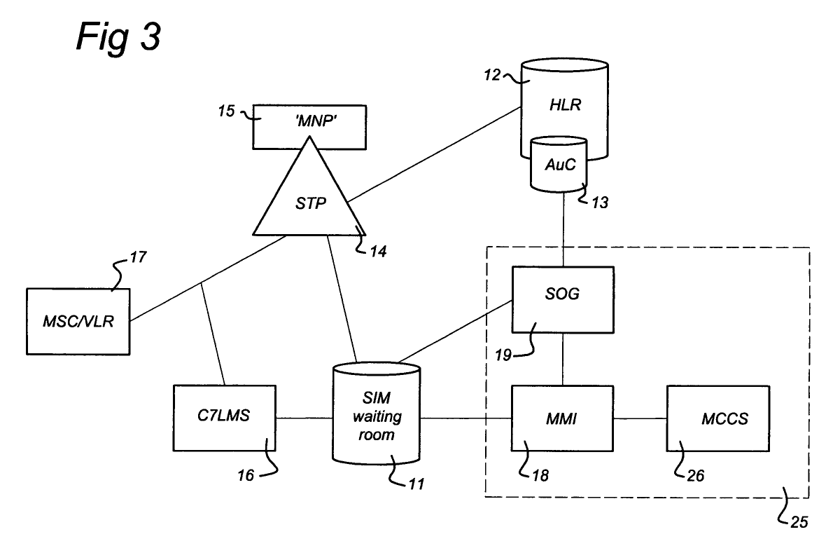

According to various embodiments of the present invention, data relating to SIM cards which are not in use (according to predefined criteria, see below), are removed from the HLR 12 and AuC 13 and stored in a SIM waiting room 11 (see description of FIG. 3 below). Only when an attempt for active use of a specific SIM card is detected (trigger), the associated data is retrieved from the SIM waiting room 11 and stored in the HLR 12 (and AuC 13) (recovery). This is shown schematically in FIG. 2 in which the first block 20 represents a switch on of a mobile station which initiates an attach request message (block 21). This message initiates a trigger process in the mobile network (block 22) after which a recovery process is started (block 23). Finally, an attachment acknowledge message is generated (block 24) which eventually reaches the associated mobile station. Both the trigger process (when is SIM data to be retrieved) and the recovery process (how is the SIM data retrieved) may be implemented in various manners, as explained below for various embodiments. The total time necessary for the trigger and recovery process should be short enough not to interfere with normal operating expectation of a mobile phone user.

The filling process of the SIM waiting room 11 may be implemented in various manners. The data in the HLR 12 and AuC 13 associated with SIM cards which have not been used for a predetermined period of time (e.g., 3 years) may be considered inactive, and are removed from the HLR 12 and AuC 13 and stored in the SIM waiting room 11. In another embodiment, data associated with newly manufactured SIM cards are stored directly in the SIM waiting room 11, and only moved to the HLR 12 and AuC 13 upon detection of a first time use.

In FIG. 3, the amended architecture for various embodiments of the present invention is shown. The SIM waiting room 11 is a separate entity and may comprise (in analogy to the HLR 12/AuC 13) separate databases for the HLR data (cold HLR) and the AuC data (cold AuC). Implementation may be different for the cold HLR and cold AuC, and may require additional hardware or be implemented in existing database entities in the mobile network (e.g., back office systems). The SIM waiting room 11 is arranged to interface with various existing entities in the mobile network, i.e., the C7LMS 16, and STP 14. Also, the SIM waiting room 11 is arranged to interface with the HLR 12 and AuC 13, either directly via a Service Order Gateway (SOG) 19, or via a Mobile Main switch Interface (MMI) 18 and the SOG 19. The MMI 18 and SOG 19 are existing elements in the mobile network, and usually a Mobile Customer Care System (MCCS) 26 is connected to the MMI 18. The MCCS 26 is arranged to provide customer data to the relevant operational systems of the mobile network, in general using the MMI 18 for keeping information in the network elements (HLR 12, AuC 13, . . . ) up to date.

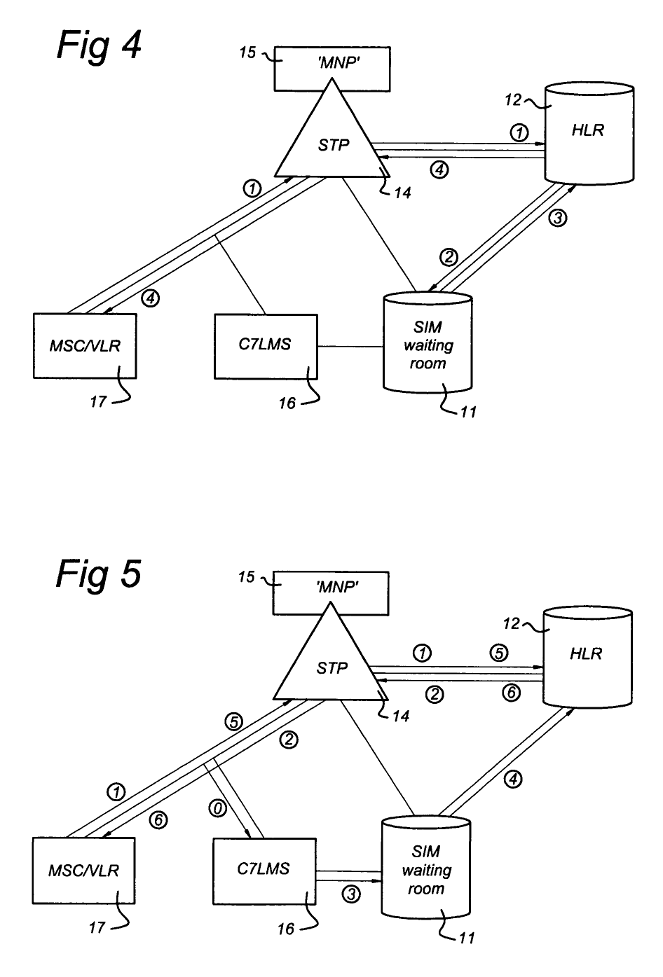

The trigger process can be implemented in various embodiments, which will be discussed with reference to the diagrams of FIG. 4-7. In these embodiments, only the HLR 12 is depicted, but it is to be understood that also data relating to the AuC 13 is equally involved in the trigger and recovery processes.

In a first embodiment of the trigger process, the trigger is detected using the HLR 12. In the following it is assumed that the SIM card (or better IMSI) is used the first time, and that data associated with that IMSI is stored in the SIM waiting room 11. The attach request message from the MSC arrives at the HLR 12 via STP 14 (reference number 1 in FIG. 4). As the specific IMSI is unknown to the HLR 12, a trigger can be generated to request the associated data from the SIM waiting room 11 in a recovery process. In this embodiment, this is implemented by amending the location update process in the HLR 12. No message is sent back to the mobile station that the IMSI is unknown. The request for IMSI data is sent directly to the SIM waiting room 11 (number 2), and the requested data is sent directly from the SIM waiting room 11 to the HLR 12 (number 3). Once the correct IMSI data has been transferred from the SIM waiting room 11 to the HLR 12, a message can be generated and sent to the mobile station via STP 14 and MSC 17 (number 4).

As a variant, a conventional error message ‘IMSI unknown’ is generated by the HLR 12 (which eventually reaches the mobile station), which may be detected by the operational and maintenance system of the mobile network. In this case, the location update process in the HLR does not have to be amended. The detection of the IMSI unknown message may be implemented in the form of a (software) filter, which upon detection initiates the recovery process to transfer the associated data from the SIM waiting room 11 to the HLR 12. Upon a second activation of the SIM card in the mobile station, the relevant IMSI data are present in the HLR 12 (and AuC 13) and a normal attachment process can be executed.

In a further embodiment, the C7LMS 16 implements the trigger process, as shown schematically in FIG. 5. In this embodiment, the conventional messaging is performed by the HLR 12, i.e., after a first attach request (number 1), a reply message ‘IMSI unknown’ is generated (number 2), which ends up with the mobile station via STP 14 and MSC 17. The C7LMS 16 is amended to detect this kind of messages (number 0), and to start the recovery process by signaling the SIM waiting room 11 (number 3). Such a modification to the C7LMS 16 is simple to implement. In the shown embodiment, the relevant data is moved directly from the SIM waiting room 11 to the HLR 12 (number 4). Upon a second attempt of the mobile station to attach to the network (number 5), a normal attachment process is executed, in which the HLR returns an acknowledgment message (number 6). In this embodiment, in the case of an unknown IMSI, always an error message is generated and transmitted throughout the system, which may result in an increased data traffic.

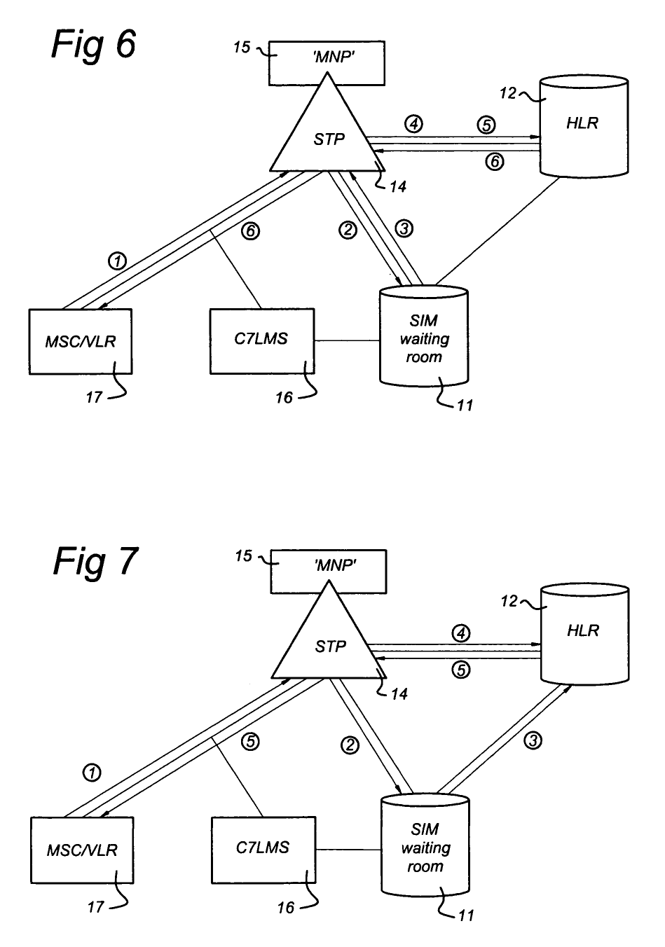

In even further alternative embodiments, which are shown schematically in FIGS. 6 and 7, the trigger process is implemented in the STP 14 (or the combination of STP 14 and MNP 15, sometimes abbreviated as MSTP). The STP 14 is already configured to analyze the IMSI number in an attach message (number 1), in order to be able to route the attach message to the proper HLR 12, using a routing table. According to this embodiment, the STP 14 is furthermore configured to analyze the IMSI number (in its entirety) and to search its routing table. If the IMSI is already present in its routing table, the attach message is routed to the proper HLR 12 in a conventional manner. If the IMSI is not present in its routing table, the recovery process is initiated by sending a message to the SIM waiting room 11 (number 2).

In the embodiment shown in FIG. 6, data associated with the specific IMSI is retrieved from the SIM waiting room by the STP 14 (number 3) and forwarded to the HLR 12 (number 4). Also, the routing table in the STP 14 is updated. Once this is achieved, the attach message can be forwarded to the HLR (number 5), which returns an acknowledgement message in a conventional way (number 6) via the STP 14 and the MSC 17 to the mobile station.

An alternative embodiment is shown in FIG. 7. After initiation of the recovery process by the STP 14 (message number 2), the associated data is sent directly from the SIM waiting room 11 to the HLR 12 (number 3). After a waiting period (necessary to complete the message transfers with number 2 and 3), the STP 14 forwards the waiting attach message to the HLR 12 (number 4) which has been updated in the mean time, and thus can return a normal attach acknowledgement message (number 5).

As mentioned above, the recovery process may also be implemented in a number of ways, which will be clarified below. In a first alternative, the data associated with an IMSI number is stored in the SIM waiting room 11 in the same format as it is stored in the HLR 12 (and AuC 13), also called technical data. In a second alternative, the data is stored in a different format, also called administrative data. This allows to enter data for the first time in the SIM waiting room 11 in a rather simple manner, but this data then must be translated into technical data before it is possible to store it in the HLR 12.

The alternative storage methods in the SIM waiting room 11 may be chosen differently for the authentication data (stored in the cold AuC) and the other SIM related data (stored in the cold HLR). In the following embodiments, only the terms technical data or administrative data is used, but it will be clear that combinations of the embodiments may be used for the AuC data and HLR data.

In the above embodiments described with reference to FIGS. 4, 5 and 7, data is moved directly from the SIM waiting room 11 to the HLR 12 (and AuC 13). In these embodiments, the data in the SIM waiting room 11 is technical data which can be used directly (without translation) in the HLR 12 (and AuC 13). Also in the embodiment of FIG. 6, the data involved may be technical data which requires no translation. An actual implementation in the mobile network may however comprise the SOG 19, as described above with reference to FIG. 3, which takes care of proper interfacing with the databases (HLR 12 and AuC 13). Furthermore, the MMI 18 may still have a role in this embodiment, as sometimes, the mapping of technical data to administrative data has to be amended for all data in the HLR 12 (and AuC 13), but also for the data in the SIM waiting room 11. Also, the MMI 18 may be used for sequence monitoring, acknowledgment mechanisms, etc.

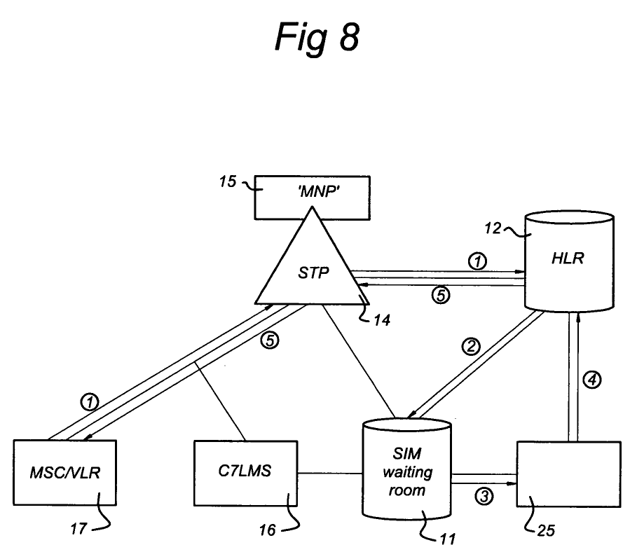

When storing administrative data in the SIM waiting room 11, a translation function has to be implemented which can translate the administrative data in technical data in near real time. E.g., in the embodiment described above with reference to FIG. 6, one of the network units may be arranged to provide the proper translation of the data involved. Also, a translation functionality may be implemented in the MMI 18, as shown in the embodiment of FIG. 8. FIG. 8 shows an embodiment with a trigger process implementation similar to the embodiment of FIG. 4, but now including an additional translation step. Administrative data from the SIM waiting room 11 is sent to the MMI 18 (number 3), which translates the data into technical data. The technical data is then transferred to the HLR 12 (number 4). After that, the HLR 12 is able to send an attachment acknowledge message in the conventional way (number 5).

In a conventional manner, the authentication keys associated with SIM cards are generated in bulk and stored in the AuC 13. The authentication keys can be considered technical data. When the SIM waiting room 11 is only implemented to store administrative data, the technical AuC data needs to be generated in the MMI 18. This requires the generation of SIM card specific keys from a master key and SIM card information (administrative data). This process has a larger processing power requirement than the direct storage of technical data in the SIM waiting room 11, but the administrative data takes less space than the technical data, thus lowering the capacity needs of the cold AuC part of the SIM waiting room 11.

Also for HLR data as stored in the cold HLR of the SIM waiting room, it is possible to either store administrative data or technical data. Also, in this case technical data requires more storage space than administrative data. On the other hand, when technical data is being stored in the SIM waiting room 11, no translation of administrative data is needed.

The above embodiments have been described and explained with reference to embodiments as examples of implementations of the present invention. As will be apparent to the skilled person, various modifications and amendments are possible within the scope of protection as defined in the appended claims.

1. Method of registering a mobile subscriber in a mobile network having a home location register (12) in which data related to a plurality of active mobile subscribers are stored, comprising detecting a first attempt of a mobile subscriber to attach to the mobile network, and subsequently updating the home location register (12) by entering data related to the mobile subscriber in the home location register (12).

2. Method according to claim 1, in which data related to a mobile subscriber which is not yet registered in the home location register (12) is stored in a second register (11), and in which the data related to the mobile subscriber is transferred from the second register (11) to the home location register (12) upon detection of the first attempt.

3. Method according to claim 1 or 2, in which the first attempt comprises sending a location update message by the mobile subscriber in the mobile network.

4. Method according to any one of claims 1 through 3, in which the first attempt is detected by:
checking whether the data of the mobile subscriber is already present in the home location register (12), and if not, updating the home location register (12).

5. Method according to any one of claims 1 through 3, in which the first attempt is detected by:
checking whether the data of the mobile subscriber is already present in the home location register (12), and if not, generating a message;
upon detection of the message, updating the home location register (12).

6. Method according to any one of claims 1 through 3,
in which the first attempt comprises a message with an identification number, further comprising checking the identification number with a list comprising identification numbers, and updating the home location register (12) accordingly.

7. Method according to any one of claims 1 through 6, in which the data of the mobile subscriber comprises an authentication key associated with the mobile subscriber.

8. Method according to any one of claims 1 through 6, in which upon detection of the first attempt, an authentication key associated with the mobile subscriber is generated and added to the data of the mobile subscriber.

9. Method according to any one of claims 1 through 8, in which upon detection of the first attempt, the data associated with the mobile subscriber is translated into a format suitable for entering in the home location register (12).

10. Method according to any one of claims 1 through 9, in which data in the home location register (12) associated with a mobile subscriber which has not been active for a predetermined time period is removed from the home location register (12).

11. Network unit for a mobile network providing communication links to a plurality of active mobile subscribers, the mobile network having a home location register (12) in which data related to the plurality of active mobile subscribers are stored, the network unit being arranged to interface with the mobile network and the home location register (12) for detecting a first attempt of a mobile subscriber to attach to the mobile network, and subsequently entering data related to the mobile subscriber in the home location register (12).

12. Network unit according to claim 11, in which the network unit is further arranged to store in a second register (11) data related to a mobile subscriber which is not yet registered in the home location register (12), and to transfer the data related to the mobile subscriber from the second register (11) to the home location register (12) upon detection of the first attempt.

13. Network unit according to claim 11 or 12, in which the network unit is arranged to detect the first attempt by detecting a location update message sent by the mobile subscriber in the mobile network.

14. Network unit according to any one of claims 11 through 13, in which the network unit comprises the home location register (12), and the network unit is arranged to check whether the data of the mobile subscriber is already present in the home location register (12), and if not, updating the home location register (12).

15. Network unit according to any one of claims 11 through 13, in which the home location register (12) is arranged to check whether the data of the mobile subscriber is already present in the home location register (12), and if not, generating a message, and in which the network unit is further arranged to update the home location register (12) upon detection of the message.

16. Network unit according to any one of claims 11 through 13, in which the first attempt comprises a message with an identification number, the network unit being arranged to store a list of identification numbers, and in which the network unit is further arranged to check the identification number with the list, and to update the home location register (12) accordingly.

17. Network unit according to any one of claims 11 through 16, in which the data of the mobile subscriber comprises an authentication key associated with the mobile subscriber.

18. Network unit according to any one of claims 11 through 16, in which the network unit is arranged to generate an authentication key associated with the mobile subscriber and to add the authentication key to the data of the mobile subscriber upon detection of the first attempt.

19. Network unit according to any one of claims 11 through 18, in which the network is further arranged to translate, upon detection of the first attempt, the data associated with the mobile subscriber into a format suitable for entering in the home location register (12).

20. Network unit according to any one of claims 11 through 19, in which the network unit is further arranged to remove data associated with a mobile subscriber which has not been active for a predetermined time period from the home location register (12).

21. Computer program product comprising computer executable code, which when loaded in a processing unit of at least one network unit in a mobile network, provides the at least one network unit in the mobile network with the functionality of the method according to one of the claims 1 through 10.
